(19) United States
(12) Patent Application Publication
(10) Pub. No.: US 2011/0248006 A1
(43) Pub. Date: Oct. 13, 2011

(54) APPARATUS AND METHOD of MANUFACTURING SPECIMEN

(75) Inventors: Seungho CHOI, Yongin-si (KR); Gwangseon Byun, Yongin-si (KR); Kyungwoo Lee, Hwaseong-si (KR); Hongshik Kim, Yongin-si (KR)

(73) Assignee: Samsung Electronics Co., Ltd, Suwon-si (KR)

(21) Appl. No.: 13/084,791

(22) Filed: Apr. 12, 2011

(30) Foreign Application Priority Data
Apr. 12, 2010 (KR) 10-2010-0033429

(51) Int. Cl. B23K 26/00

(52) U.S. Cl. 219/121.72

(57) ABSTRACT

An apparatus and a method of manufacturing a specimen. The specimen manufacturing apparatus can include a stage to put a substrate thereon, and a laser beam unit to emit a laser beam to the substrate to cut out a specimen having an analysis region from the substrate.

### CROSS-REFERENCE TO RELATED APPLICATIONS

This U.S. non-provisional patent application claims priority under 35 U.S.C. §119(a) from Korean Patent Application No. 10-2010-0033429, filed on Apr. 12, 2010, the entire contents of which are hereby incorporated by reference.

### BACKGROUND

1. Field of the Invention

The present general inventive concept herein relates to an apparatus and a method of manufacturing a specimen, and more particularly, to an apparatus and a method of manufacturing a specimen to be analyzed by a transmission electron microscope (TEM).

2. Description of the Related Art

Generally, during a semiconductor device manufacturing process, a plurality of films are formed on a wafer as deposition is repeatedly performed. If a defect occurs on a certain film of the plurality of films, abnormality consequently occurs in a semiconductor device manufactured by subsequent processes. To this end, it is necessary to select a wafer having a defect from wafers under the semiconductor manufacturing process and cut out a specimen for analysis from the wafer to determine a defect of a specific film. A TEM is used for the analysis. The specimen for analysis is formed into a thin section having thickness of about 1 μm or less to enable entry and transmission of electrons accelerated through a high potential difference.

### SUMMARY

The present general inventive concept provides an apparatus and a method of automatically manufacturing a specimen.

Additional features and utilities of the present general inventive concept will be set forth in part in the description which follows and, in part, will be obvious from the description, or may be learned by practice of the present general inventive concept.

Exemplary embodiments of the present general inventive concept may provide specimen manufacturing apparatuses including a stage to put a substrate thereon, and a laser beam unit to emit a laser beam to the substrate put on the stage to cut out a specimen including an analysis region from the substrate.

The specimen manufacturing apparatus may include a stage driver to move the substrate in vertical and horizontal directions and rotate the substrate, and the stage driver may move the stage relative to the laser beam unit.

The substrate may include a defect, and the laser beam unit may cut out the specimen from the substrate such that the defect is included in the analysis region.

The specimen manufacturing apparatus may further include a defect inspection unit to detect a position of the defect formed in the substrate before the substrate is loaded on to the stage.

The specimen manufacturing apparatus may further include a controller to receive a signal including the position of the defect from the defect inspection unit and to control the stage driver such that the defect of the substrate put on the stage is disposed below the laser beam unit.

The specimen may include a base, and a projecting part to project from an upper surface of the base to include the analysis region at an upper end thereof, and the laser beam unit may remove regions around the base and the projecting part.

The laser beam unit may include a power supply member, and a laser beam emitting member to generate the laser beam using a current supplied by the power supply member and emit the laser beam to the substrate, and the power supply member may supply the laser beam emitting member with the current of different intensities according to regions to be removed.

The intensity of the current to remove the region around the projecting part may be smaller than the intensity of the current to remove the region around the base.

In exemplary embodiments of the present general inventive concept, a method of manufacturing a specimen can include loading a substrate to be analyzed on to a stage, and cutting out a specimen including an analysis region from the substrate by emitting a laser beam to the substrate with a laser beam unit.

The substrate may include a plurality of defects, and the method may include detecting positions of the defects before loading the substrate and cutting out the specimen including each of the defects sequentially from the substrate.

When the specimen is cut out from the substrate, the stage may be moved based on the detected positions of the defects such that the defects are aligned with the laser beam unit.

The specimen may include a base, and a projecting part that projects from an upper surface of the base to include the defect at an upper end thereof and extending in a length direction of the base, and the specimen may be cut out from the substrate as regions around the base and the projecting part are removed by the laser beam.

A first intensity of the laser beam to remove a region around the projecting part may be smaller than a second intensity of the laser beam to remove a region around the base.

The base may have a rod shape having a rectangular cross-section, the projecting part may have a rod shape having a rectangular cross-section with a smaller width than the cross-section of the base, and the cross-section of the projecting part may be disposed in a middle of the cross-section of the base.

A recess may be formed on at least one of both longitudinal side surfaces of the projecting part.

The recess may be formed in a projecting direction of the projecting part to be opened at an upper end thereof.

The base may have a rod shape having a rectangular cross-section, and the projecting part may have a rod shape having a cross-section which has a smaller width than the cross-section of the base and has a gradually decreasing width toward an upper part in a stepwise manner.

The base may have a rod shape having a rectangular cross-section, the projecting part may have a rod shape having a rectangular cross-section with a smaller width than the cross-section of the base, and the cross-section of the projecting part may be disposed on one side of an outline of the cross-section of the base.

Surfaces forming a corner between the base and the projecting part may be inclined.

A corner formed between the base and the projecting part may be curved.

Exemplary embodiments of the present general inventive concept also provide a method of manufacturing a specimen, the method including determining positions of defects formed on a substrate, aligning a laser beam emission unit with the determined positions of the defects of the substrate, and cutting out a specimen including at least one of the determined defects from the substrate with a laser beam that is emitted by the laser beam emission unit.

The cutting of the method may include removing regions around a base and a projecting part of the specimen with the emitted laser beam.

The method may include where the intensity of the emitted laser beam is greater when removing regions around the base than when removing regions around the projecting part.

Exemplary embodiments of the present general inventive concept may also provide a specimen manufacturing apparatus, including a detector to determine positions of defects formed on a substrate, a controller to control a driver of a stage on which the substrate is mounted to align a laser beam emission unit with the determined positions of the defects of the substrate, and the laser beam emission unit to cut out a specimen including at least one of the determined defects from the substrate with a laser beam that is emitted by the laser beam emission unit.

The specimen manufacturing apparatus may include where the controller receives the positions of the defects formed on the substrate from the detector.

### BRIEF DESCRIPTION OF THE DRAWINGS

The above and/or other utilities of the present general inventive concept will become apparent and more readily appreciated from the following description of the exemplary embodiments, taken in conjunction with the accompanying drawings, in which:

FIG. 1 is a block diagram illustrating the structure of a specimen manufacturing apparatus according to exemplary embodiments of the present general inventive concept;

FIG. 2A is a view illustrating a specimen manufacturing unit of FIG. 1 according to exemplary embodiments of the present general inventive concept;

FIGS. 2B-2C illustrate methods of manufacturing a specimen according to exemplary embodiments of the present general inventive concept;

FIG. 3 is a view illustrating a method of aligning defects of a substrate with a laser beam emitting member according to exemplary embodiments of the present general inventive concept;

FIG. 4A is an enlarged view of a region around a first defect illustrated in FIG. 3;

FIG. 4B illustrates a sectional view of FIG. 3, cut along a line A-A′;

FIG. 5 is a view illustrating an example of a specimen for analysis by a transmission electron microscope (TEM) according to exemplary embodiments of the present general inventive concept;

FIG. 6A and FIG. 7A are views illustrating operations of manufacturing the specimen using a laser beam according to exemplary embodiments of the present general inventive concept;

FIG. 6B illustrates a sectional view of FIG. 6A, cut along a line B-B′;

FIG. 7B illustrates a sectional view of FIG. 7A, cut along a line C-C′; and

FIGS. 8 through 13 are views illustrating examples of the specimen for analysis by a TEM according to exemplary embodiments of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

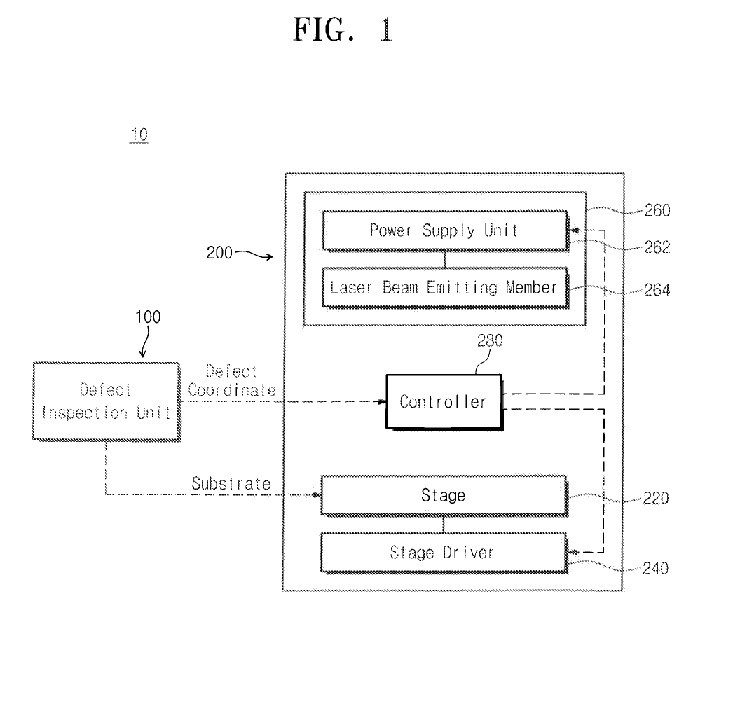

FIG. 1 is a block diagram illustrating the structure of a specimen manufacturing apparatus according to exemplary embodiments of the present general inventive concept. Referring to FIG. 1, the specimen manufacturing apparatus 10 can manufacture a specimen to analyze a sample by a transmission electron microscope (TEM). The specimen manufacturing apparatus 10 can a defect inspection unit 100 and a specimen manufacturing unit 200.

The defect inspection unit 100 can scan a pattern surface of a substrate and can detect position information of defects formed in the substrate, that is, defect coordinates. The specimen manufacturing unit 200 can receive a substrate and the defect coordinates from the defect inspection unit 100 and can manufacture a specimen including the defects directly at the defect coordinates on the substrate. Here, manufacturing of the specimen can be performed in sequence according to the defect coordinates.

Typically, an operator manually cuts out a part of the substrate and manufactures a specimen that includes defects using the cut-out part of the substrate. In exemplary embodiments of the present general inventive concept, the specimen manufacturing unit 200 can manufacture the specimen directly on the whole substrate in an automated manner without cutting the substrate. Although a focused on beam (FIB) is typically used in manufacturing the specimen, the specimen manufacturing unit 200 according to the exemplary embodiments of the present general inventive concept uses a laser beam.

A substrate without defects and/or with minimized defects may be loaded to the specimen manufacturing unit 200. The specimen manufacturing unit 200 may manufacture the specimen on a predetermined position on the substrate to inspect a cross-section of the substrate by a TEM to determine whether deposition of a specific film is normally performed, whether a contact hole is normally filled, and the like. That is, the cross-section of the substrate may be inspected by the TEM to determine whether a film has been disposed on the substrate using a predetermined operation. The cross-section of the substrate may be inspected to determine whether there are one or more defects and/or voids in the substrate.

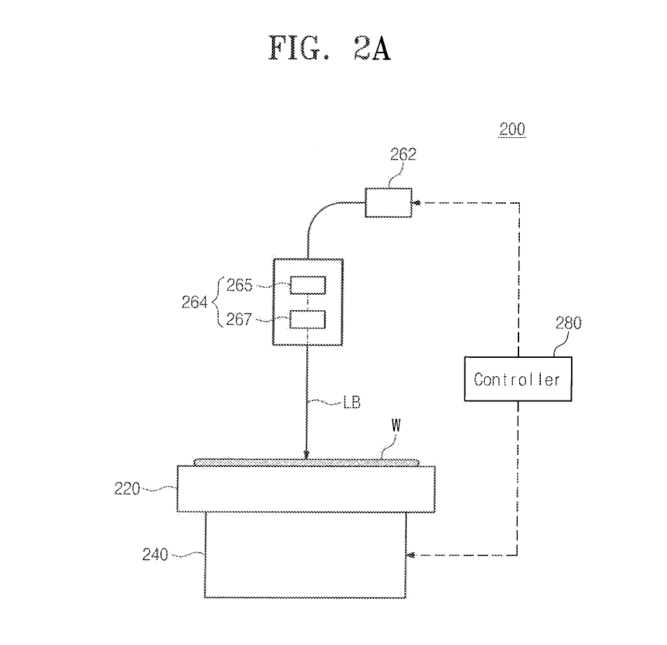

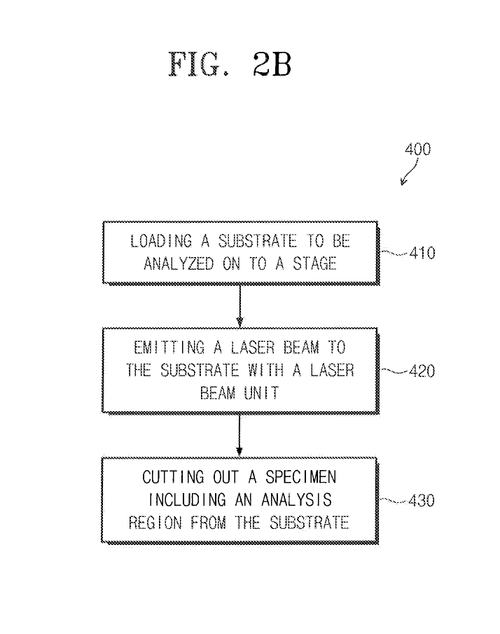

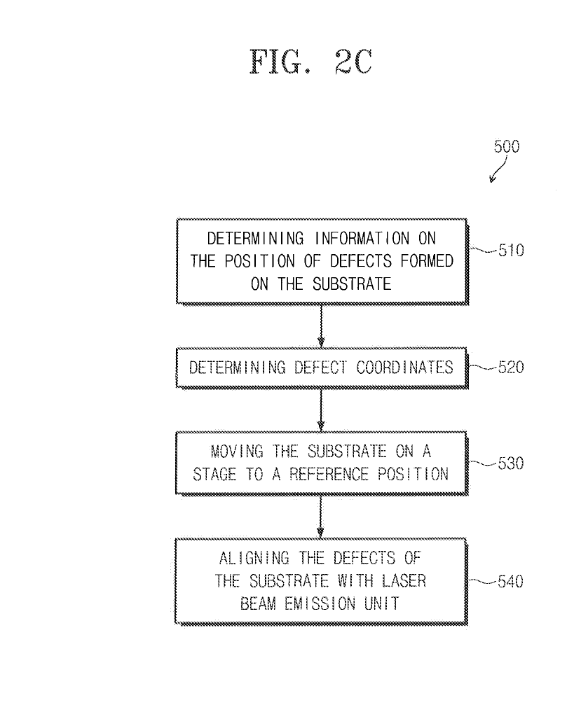

FIG. 2A is a view illustrating the specimen manufacturing unit of FIG. 1 according to exemplary embodiments of the present general inventive concept. FIG. 2B illustrates a method 400 of manufacturing a specimen. Referring to FIGS. 1, 2A, and 2B, the specimen manufacturing unit 200 can include a stage 220, a stage driver 240, a laser beam unit 260, and a controller 280.

A substrate W can be loaded to the stage 220 at operation 410. The substrate W may include defects. The stage deriver 240 may linearly move the stage 220 in vertical and horizontal directions and also rotate the stage 220 about a vertical rotation axis thereof. The substrate W can be linearly moved or rotated according to the linear movements and rotation of the stage 220. The stage driver 240 can rotate the stage 220 to arrange the substrate W at a reference position on the stage 220. The stage driver 240 can linearly move the stage 220 in vertical and horizontal directions to manufacture the specimen on the substrate W.

The laser beam unit 260 can be disposed above the stage 220. The laser beam unit 260 can emit a laser beam (LB) vertically downward to the substrate W disposed on the stage 220 at operation 420, thereby cutting out the specimen including the defects from the substrate W at operation 430. The laser beam unit 260 can include a power supply member 262 and a laser beam emitting member 264. The power supply member 262 can supply an electric current to the laser beam emitting member 264. The laser beam emitting member 264 can generate the laser beam LB and can emit the laser beam LB to the substrate W (e.g., at operation 420 illustrated in FIG. 2B). The electric current supplied by the power supply member 262 can be applied to a laser oscillator 265 of the laser beam emitting member 264. The laser oscillator 265 can generate the laser beam LB using the applied current. The generated laser beam LB can be passed through an optical system 267 and emitted to the substrate W (e.g., at operation 420 illustrated in FIG. 2B). The optical system 267 may include one or more lenses and/or prisms to collimate and/or focus the generated laser beam.

The controller 280 can control the stage driver 240 and the power supply member 262 of the laser beam unit 260. Specifically, the controller 280 can receive signals including the defect coordinates from the defect inspection unit 100 and can control the stage driver 240 such that the defects of the substrate W disposed on the stage 220 can be arranged below the laser beam unit 260. The controller 280 may control the stage driver 240 such that the laser beam LB emitted vertically downward from the laser beam unit 260 which is in a fixed position can remove regions around the defects. The controller 280 may control the power supply member 262 of the laser beam unit 260 to adjust intensity of the laser beam LB.

The controller 280 may be a processor, a programmable logic device, a field programmable gate array, an application specific integrated circuit, and/or any other suitable device to carry out the exemplary embodiments of the present general inventive concept as disclosed herein.

Hereinafter, a method of manufacturing the specimen using the above-structured specimen manufacturing apparatus will be explained with reference to FIGS. 1, 2A and 2C.

The defect inspection unit 100 can scan the pattern surface of the substrate, thereby detecting the information on the positions of the defects formed on the substrate, that is, the defect coordinates for manufacturing of the specimen. The information on the positions of the defects may be detected at operation 510 of method 500 illustrated in FIG. 2C, and the defect coordinates may be determined at operation 520. The detected defect coordinates can be transmitted to the controller 280 of the specimen manufacturing unit 200. The substrate can be transferred to the stage 220 of the specimen manufacturing unit 200. The substrate W transferred to the stage 220 can be arranged at the reference position at operation 530 by rotation of the stage 220. The defects of the substrate W can be aligned with the laser beam emission unit 264 at operation 540 by a horizontal movement of the stage 220.

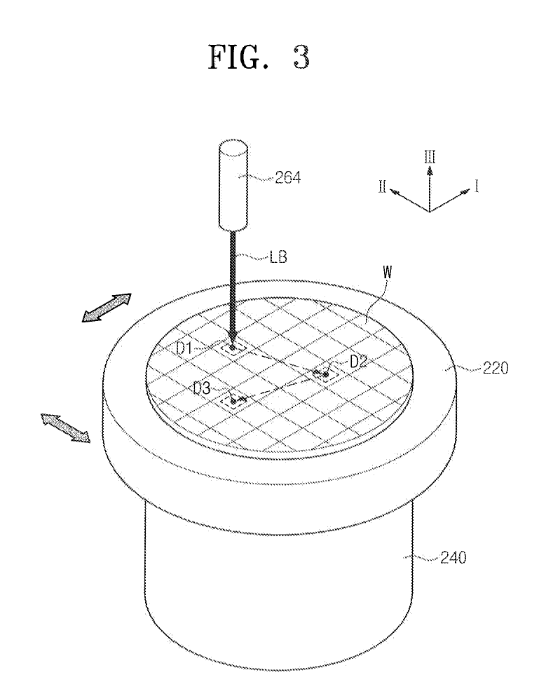

FIG. 3 is a view illustrating a method of aligning the defects of the substrate with the laser beam emitting member. Referring to FIG. 3, the substrate W including a plurality of defects D1, D2 and D3 can be loaded to the stage 220. The stage driver 240 can rotate the stage 220 about the vertical rotation axis thereof, thereby disposing the substrate at the reference position. The controller 280 can control the stage driver 240 based on the defect coordinates. The stage driver 240 can move the stage 220 in a horizontal direction, that is, in a first direction I and a second direction II when controlled by the controller 280, such that the first defect Di of the substrate W is disposed below the laser beam emitting member 264. Here, the laser beam emitting member 264 can be fixed in a specific position (e.g., a predetermined position).

When the first defect D1 is aligned, a specimen manufacturing process can be performed at a position of the first defect D1. Alignment of the second defect D2 and the specimen manufacturing process at a position of the second defect D2, and alignment of the third defect D3 and the specimen manufacturing process at a position of the third defect D3 may be sequentially performed.

Hereinafter, there will be explained the structure of a cross-section of a region around the defect where the specimen manufacturing process may be performed. A shape of the specimen to be manufactured in this region will be explained.

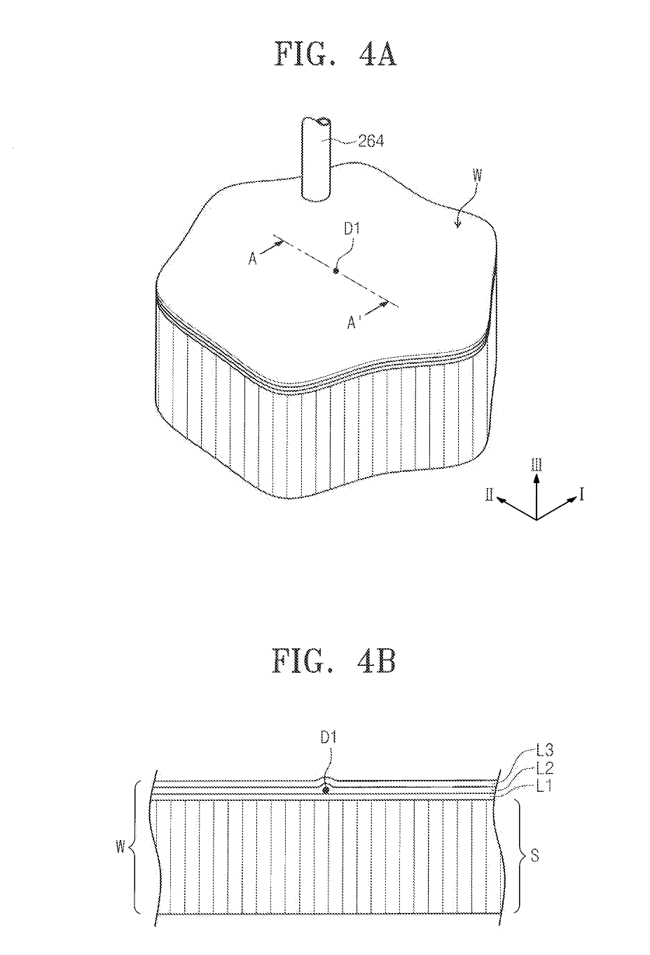

FIG. 4A illustrates an enlarged view of the region around the first defect illustrated in FIG. 3. FIG. 4B is a sectional view of FIG. 3, cut along a line A-A. Referring to FIGS. 4A and 4B, the substrate W may include a base substrate S and first to third film layers L1, L2, and L3 (i.e., first film layer L1, second film layer L2, and thirds film layer L3) disposed sequentially on the base substrate S. For example, when the first defect D1 is disposed between the first film layer L1 and the second film layer L2, the substrate W may be contaminated between a deposition process of the first film layer L1 and a deposition process of the second film layer L2. Thus, the processing error may be determined by analysis of the cross-section of the substrate W. A TEM may be used for the analysis.

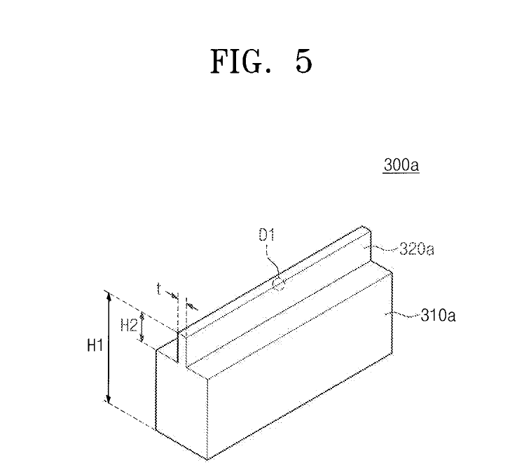

A specimen including defects can be used in analysis of the cross-section of the substrate W using the TEM. FIG. 5 illustrates an example of the specimen. The specimen may have one or more different shapes and/or features, as will be explained in detail hereinafter.

FIG. 5 illustrates a specimen for analysis by a TEM, according to exemplary embodiments of the present general inventive concept. Referring to FIG. 5, a specimen 300a can include a base 310a and a projecting part 320a. The base 310a can have a rod shape having a rectangular cross-section. The projecting part 320a may be in a rod shape having a rectangular cross-section with a smaller width than the cross-section of the base 310a. The projecting part 320a can project from an upper surface of the base 310a. More specifically, the cross-section of the projecting part 320a may be disposed substantially in a middle of the cross-section of the base 310a.

For example, a total height H1 of the specimen may be approximately 800 μm, a height H2 of the projecting part 320a may be approximately 100 μm, and a cross-sectional width (t) of the projecting part 320a, that is, thickness (t) of the projecting part 320a may be approximately 1 μm or less. An upper end part of approximately 4˜7 of the projecting part 320a can be used for analysis by the TEM. The first defect D1 can be included in the upper end part of approximately 4˜7 μm.

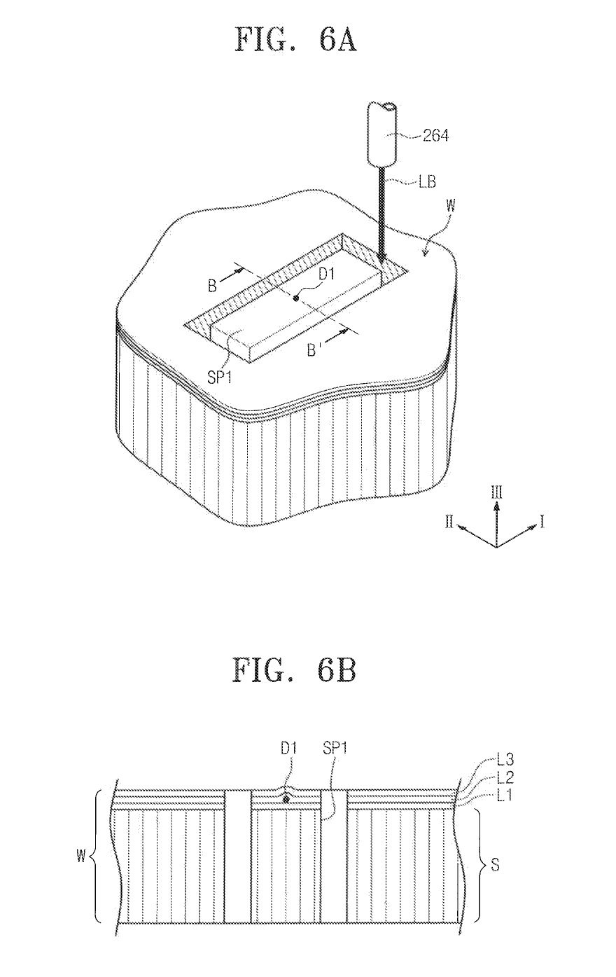

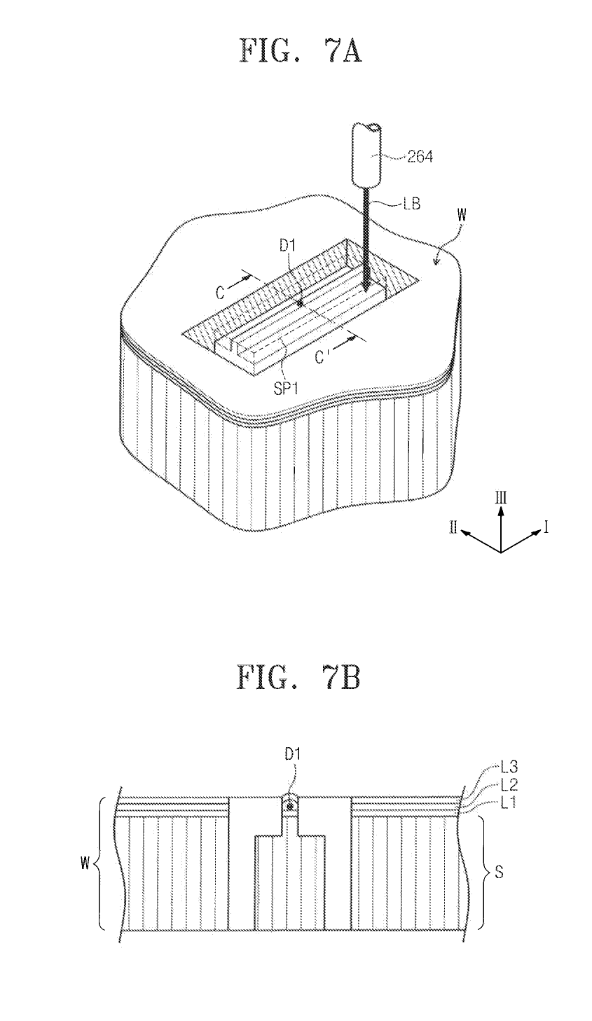

The process of manufacturing the specimen in the position of the first defect D1 can be performed as follows. FIGS. 6A and 7A are views illustrating processes of manufacturing the specimen using a laser beam. FIG. 6B illustrates a sectional view of FIG. 6A, cut along a line B-B′. FIG. 7B illustrates a sectional view of FIG. 7B, cut along a line C-C′.

Referring to FIGS. 6A and 6B, the laser beam emitting member 264 can be fixed in a position out of the first defect D1 and can emit the laser beam LB vertically downward to the substrate W. The laser beam LB can etch the substrate W in a penetrating manner. Here, the substrate can be horizontally moved in the first and second directions I and II such that a preliminary specimen SP1 including the first defect D1 is formed into a rectangular parallelepiped shape through etching by the laser beam LB.

Referring to FIGS. 7A and 7B, when the preliminary specimen SP1 is manufactured, the substrate W and the preliminary specimen SP1 can be moved and, therefore, the laser beam emitting member 264 can be disposed above an upper surface of the preliminary specimen SP1. The laser beam emitting member 264 can emit the laser beam LB to the upper surface of the preliminary specimen SP1 in the fixed position. The laser beam LB can etch the upper surface of the preliminary specimen SP1 by depth corresponding to the height H2 of the projecting part 320a shown in FIG. 5. The preliminary specimen SP1 can be moved horizontally in the first and second directions I and II such that a region of the upper surface of the preliminary specimen SP1 other than a middle region corresponding to the thickness of the projecting part 320a can be etched. The intensity of the laser beam LB may be smaller than intensity of the laser beam LB used in etching an outline of the preliminary specimen SP1. The intensity of the laser beam LB may be controlled by the current supplied from the power supply member 262 (illustrated in FIG. 2A) to the laser oscillator 265 (illustrated in FIG. 2A).

As described above, the specimen as illustrated in FIG. 5 can be manufactured. Hereinafter, other examples of the specimen for analysis by the TEM will be described. Those specimens may also be manufactured directly on the substrate by using a laser beam. Therefore, only shapes of the specimens will be explained and a description of the specimen manufacturing processes will be omitted.

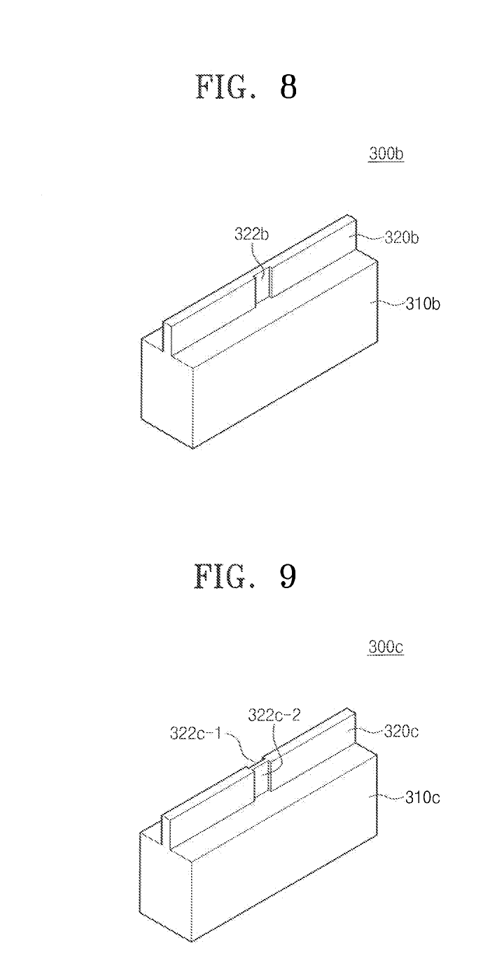

FIGS. 8 through 13 are views illustrating specimens for analysis by a TEM, according to other embodiments of the inventive concept.

As illustrated in FIG. 8, a specimen 300b can include a base 310b and a projecting part 320b. The base 310b and the projecting part 320b can be the same as the base 310a and the projecting park 320a of the specimen 300a illustrated in FIG. 5 and described above. A recess 322b can be formed on one longitudinal side surface of the projecting part 320b. The recess 322b may extend in a projecting direction of the projecting part 320b to be opened at an upper end thereof and may be disposed substantially in a middle of the longitudinal side surface.

Referring to FIG. 9, a specimen 300c can include a base 310c and a projecting part 320c. The base 310c and the projecting part 320c can be the same as the base 310a and the projecting part 320a of the specimen 300a illustrated in FIG. 5 and described above. Recesses 322c-1 and 322c-2 can be formed on both longitudinal side surfaces of the projecting part 320c. The recesses 322c-1 and 322c-2 may extend in a projecting direction of the projecting part 320c to be opened at upper ends thereof and be disposed substantially in middles of the longitudinal side surfaces.

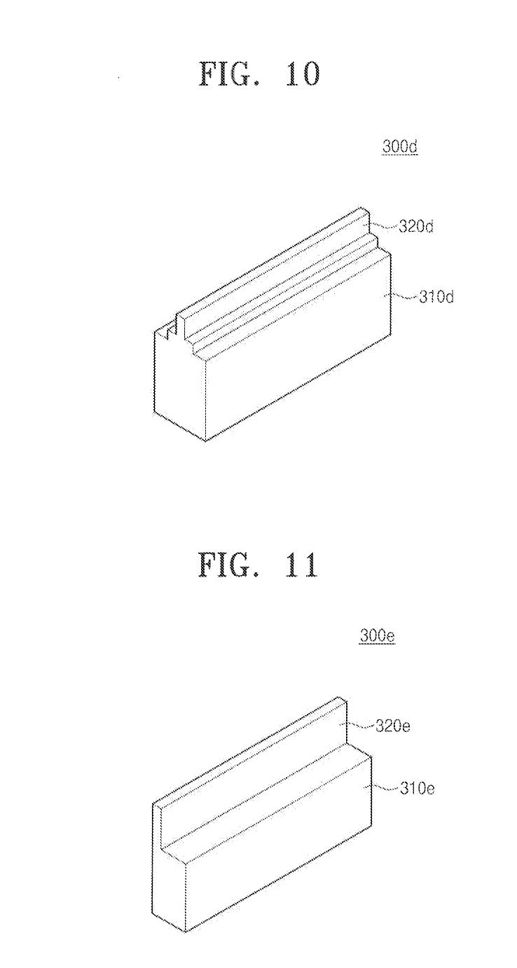

Referring to FIG. 10, a specimen 300d can include a base 310d and a projecting part 320d. The base 310d can have a rod shape having a rectangular cross-section. The projecting part 320d can have a rod shape having a cross-section with a smaller width than the cross-section of the base 310d. The cross-section of the projecting part 320d can have a gradually decreasing width toward an upper part in a stepwise manner. The projecting part 320d can project from an upper surface of the base 310d.

Referring to FIG. 11, a specimen 300e can include a base 310e and a projecting part 320e. The base 310e can have a rod shape having a rectangular cross-section and the projecting part 320e can have a rod shape having a rectangular cross-section with a smaller width than the cross-section of the base 310e. The projecting part 320e can project from an upper surface of the base 310e. The projecting part 320e may project such that the cross-section thereof is disposed on one side of an outline of the cross-section of the base 310e.

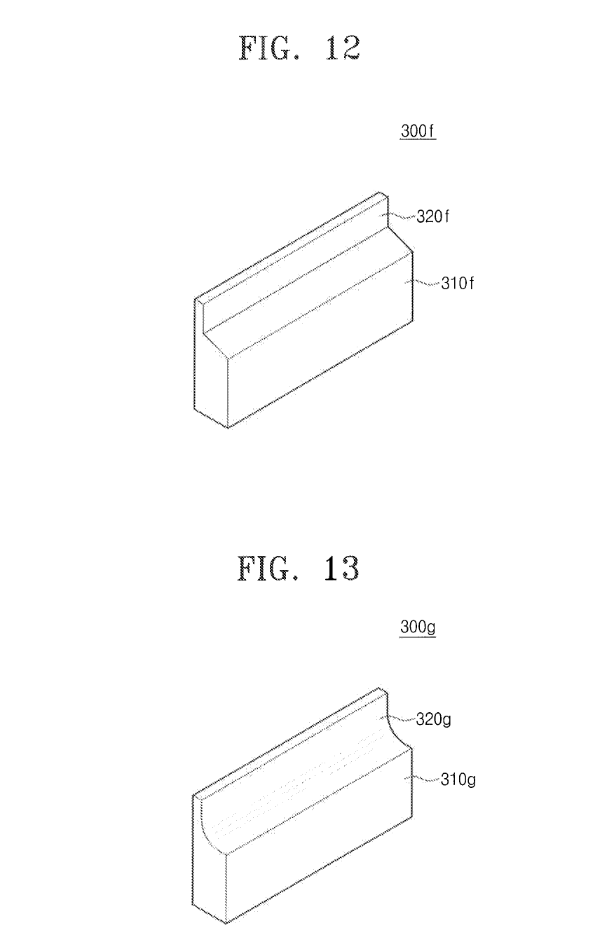

Referring to FIG. 12, a specimen 300f can include a base 310f and a projecting part 320f. The base 310f and the projecting part 320f may be the same as the base 310e and the projecting part 320e of the specimen 300e illustrated FIG. 11 and described above. Surfaces forming a corner between the base 310f and the projecting part 320f may be inclined to prevent a crack by concentration of stress on the corner.

Referring to FIG. 13, a specimen 300g can include a base 310g and a projecting part 320g. The base 310g and the projecting part 320g may be the same as the base 310e and the projecting part 320e of the specimen 300e illustrated in FIG. 11 and described above. A corner formed between the base 310g and the projecting part 320g may be curved to prevent a crack by concentration of stress on the corner.

The specimen manufacturing apparatus according to the exemplary embodiments of the present general inventive concept can manufacture specimens having one or more forms as described above directly on the substrate in an automated manner. Therefore, specimen manufacturing time may be reduced compared to when the specimen is manually manufactured. The uniformity of the specimen quality may be improved.

According to the above description, specimen manufacturing time may be reduced and uniformity of specimen quality may be improved by manufacturing the specimen in an automated system.

The specimen may be manufactured directly from a substrate by using a laser beam.

Although several embodiments of the present invention have been shown and described, it would be appreciated by those skilled in the art that changes may be made in these embodiments without departing from the principles and spirit of the general inventive concept, the scope of which is defined in the claims and their equivalents.

1-8. (canceled)

9. A method of manufacturing a specimen, the method comprising:
loading a substrate to be analyzed on to a stage; and
cutting out a specimen including an analysis region from the substrate by emitting a laser beam to the substrate with a laser beam unit.

10. The method of claim 9, wherein the substrate includes a plurality of defects, the method further comprising:
detecting positions of the defects before loading the substrate; and
cutting out the specimen including each of the defects sequentially from the substrate.

11. The method of claim 10, further comprising:
moving the stage based on the detected positions of the defects such that the defects are aligned with the laser beam unit when the specimen is cut out from the substrate.

12. The method of claim 10, wherein the specimen includes a base, and a projecting part that projects from an upper surface of the base to include the defect at an upper end thereof and extending in a length direction of the base, and
wherein the specimen is cut out from the substrate as regions around the base and the projecting part are removed by the laser beam.

13. The method of claim 12, wherein a first intensity of the laser beam to remove a region around the projecting part is smaller than a second intensity of the laser beam to remove a region around the base.

14. The method of claim 12, wherein the base has a rod shape having a rectangular cross-section,
the projecting part has a rod shape having a rectangular cross-section with a smaller width than the cross-section of the base, and
the cross-section of the projecting part is disposed in a middle of the cross-section of the base.

15. The method of claim 14, further comprising:
forming a recess on at least one of both longitudinal side surfaces of the projecting part.

16. The method of claim 15, wherein the recess is formed in a projecting direction of the projecting part to be opened at an upper end thereof.

17. The method of claim 12, wherein the base has a rod shape having a rectangular cross-section, and
the projecting part has a rod shape having a cross-section which has a smaller width than the cross-section of the base and has a gradually decreasing width toward an upper part in a stepwise manner.

18. The method of claim 12, wherein the base has a rod shape having a rectangular cross-section,
the projecting part has a rod shape having a rectangular cross-section with a smaller width than the cross-section of the base, and
the cross-section of the projecting part is disposed on one side of the cross-section of the base.

19. The method of claim 18, wherein surfaces forming a corner between the base and the projecting part are inclined.

20. The method of claim 18, wherein a corner formed between the base and the projecting part is curved.

21. A method of manufacturing a specimen, the method comprising:
determining positions of defects formed on a substrate;
aligning a laser beam emission unit with the determined positions of the defects of the substrate; and
cutting out a specimen including at least one of the determined defects from the substrate with a laser beam that is emitted by the laser beam emission unit.

22. The method of claim 21, wherein the cutting comprises:
removing regions around a base and a projecting part of the specimen with the emitted laser beam.

23. The method of claim 22, wherein the intensity of the emitted laser beam is greater when removing regions around the base than when removing regions around the projecting part.

24-25. (canceled)
